(19) United States
(12) Patent Application Publication
(10) Pub. No.: US 2009/0287668 A1
(43) Pub. Date: Nov. 19, 2009

(54) Methods and apparatus for interactive document clustering

(75) Inventors: David A. Evans, Pittsburgh, PA (US); Victor M. Sheftel, Bethel Park, PA (US); Jeffrey Bennett, Pittsburgh, PA (US)

Correspondence Address: JONES DAY, 222 EAST 41ST ST, NEW YORK, NY, 10017, US

(73) Assignee: JustSystems Evans Research, Inc., Pittsburgh, PA (US)

(21) Appl. No.: 12/153,331

(22) Filed: May 16, 2008

(51) Int. Cl. G06F 7/06; G06F 17/30

(52) U.S. Cl. 707/4; 707/E17.046; 707/E17.014

(57) ABSTRACT

A computer-based process is described for identifying clusters of documents that have some degree of similarity from among a set of documents that permits user interaction with the process. A plurality of seed candidate documents is identified. Candidate probes based upon the seed candidate documents are generated, and information regarding the candidate probes is displayed to a user. User input regarding the candidate probes is received, and a set of probes from which to form clusters of documents are defined based upon the user input regarding the candidate probes. A probe is selected and a cluster of documents is formed from among available documents not yet clustered using the probe. The process can be repeated to generate further clusters. The process can be implemented with a computer system, and associated programming instructions can be contained within a computer readable medium.

### BACKGROUND

1. Field of the Invention

The present disclosure relates to computerized analysis of documents, and in particular, to identifying clusters of documents that are similar from among a set of documents.

2. Background Information

Rapid growth in the quantity of unstructured electronic text has increased the importance of efficient and accurate document clustering. By clustering similar documents, users can explore topics in a collection without reading large numbers of documents. Organizing search results into meaningful flat or hierarchical structures can help users navigate, visualize, and summarize what would otherwise be an impenetrable mountain of data.

Hierarchical (agglomerative and divisive) clustering methods are known. Hierarchical agglomerative clustering (HAC) starts with the documents as individual clusters and successively merges the most similar pair of clusters. Hierarchical divisive clustering (HDC) starts with one cluster of all documents and successively splits the least uniform clusters. A problem for all HAC and HDC methods is their high computational complexity (O(n²) or even O(n³)), which makes them unscaleable in practice.

Partitional clustering methods based on iterative relocation are also known. To construct K clusters, a partitional method creates all K groups at once and then iteratively improves the partitioning by moving documents from one group to another in order to optimize a selected criterion function. Major disadvantages of such methods include the need to specify the number of clusters in advance, assumption of uniform cluster size, and sensitivity to noise.

Density-based partitioning methods for clustering are also known. Such methods define clusters as densely populated areas in a space of attributes, surrounded by noise, i.e., data points not contained in any cluster. These methods are targeted at primarily low-dimensional data.

In conventional clustering approaches, document clustering is a completely unsupervised process that requires a complete analysis of the entire document collection under consideration in order to form the clusters. Further, in conventional clustering approaches, the results of document clustering are only available after clustering the entire document collection is finished. Moreover, in conventional clustering, the quality of document clustering (i.e., the meaningfulness and relevance of the clusters to a user) is not controllable and cannot be assessed by a user until clustering is complete.

The present inventors have observed that it may be desirable for a user to discover only certain clusters of documents, such that there is no need to cluster the entire document collection. The present inventors have further observed that it may be desirable for a user to guide a document clustering process so as to enhance the relevance of the clusters formed. Accordingly, the present inventors have determined that a semi-supervised, interactive document clustering method would be desirable, wherein the method can allow the user to preview the most popular coherent topics in the database, guide the clustering process, and then create document clusters only for selected topics.

### SUMMARY

It is an object of the invention to produce precise, meaningful clusters of documents that are similar with user interaction and supervision.

It is another object of the invention to produce precise, meaningful clusters of documents without carrying out clustering on the entire document collection under consideration.

According to one aspect, an exemplary method for identifying clusters of documents from among a set of documents comprises: (a) identifying a plurality of seed candidate documents; (b) generating candidate probes based upon the seed candidate documents, the candidate probes each comprising one or more features from the seed candidate documents; (c) displaying information regarding the candidate probes to a user; (d) receiving user input regarding the candidate probes and defining a set of probes from which to form clusters of documents based upon the user input regarding the candidate probes; (e) selecting a probe and forming a cluster of documents from among available documents of the set of documents using the probe, wherein forming the cluster of documents comprises finding documents that satisfy a similarity condition relative to the probe and associating some or all of the documents that satisfy the similarity condition with a particular cluster of documents; and (f) repeating step (e) using another probe as the probe and using another similarity condition as the similarity condition until a halting condition is satisfied to form at least one other cluster of documents, wherein those documents of the set of documents previously associated with a cluster of documents are not included among the available documents.

According to another aspect an apparatus comprises a memory and a processing system coupled to the memory, wherein the processing system is configured to execute the above-noted method.

According to another aspect, a computer readable medium comprises processing instructions adapted to cause a processing system to execute the above-noted method.

### BRIEF DESCRIPTION OF THE FIGURES

FIG. 1A illustrates a page of an exemplary graphical user interface (GUI) that can be implemented on a conventional personal computer or any other suitable computer permitting interaction and user direction of a clustering process according to one aspect.

FIG. 1B illustrates an exemplary pop-up window of a GUI for selecting a data source of documents to be clustered according to an exemplary aspect.

FIG. 1C illustrates another exemplary pop-up window of a GUI for providing information about a data source of documents that may be selected for clustering according to an exemplary aspect.

FIG. 2 illustrates an exemplary flow diagram of a clustering method for identifying clusters of documents that permits user interaction and direction of the clustering process according to an exemplary aspect.

FIG. 3 illustrates an exemplary pop-up window contain document text that can be displayed according to an exemplary aspect.

FIG. 4 illustrates an exemplary pop-up window illustrating information regarding candidate probes according to an exemplary aspect.

FIG. 5 illustrates an exemplary pop-up window pop-up window containing a list of the terms (or features) of a probe candidate and weighting coefficients associated with the respective terms according to an exemplary aspect.

FIG. 6 illustrates an exemplary pop-up window before (left hand side) a highlighted term is removed from a candidate probe by a user and after (right hand side) the term has been removed by the user according to an exemplary aspect.

FIG. 7 illustrates an exemplary pop-up window showing probe summaries for probe candidates that were retained based on user input according to one exemplary aspect.

FIG. 8 illustrates an exemplary pop-up window that can be displayed in response to a user command to see cluster results according to an exemplary aspect.

FIG. 9 illustrates an exemplary pop-up window that can be displayed to provide a user with further information about cluster results and for permitting a user to reject selected clusters according to an exemplary aspect.

FIG. 10 illustrates an exemplary flow diagram for identifying multiple seed candidate documents that may be potentially used in generating clusters of documents according to an exemplary aspect.

FIG. 11 illustrates an exemplary block diagram of a computer system on which exemplary approaches for forming clusters of documents can be implemented according to an exemplary aspect.

### DETAILED DESCRIPTION

Exemplary computer-based clustering approaches are described herein for identifying clusters of documents that have some degree of similarity from among a set of documents. The exemplary clustering approaches described herein permit user interaction and guidance of the clustering process. Such user interaction and guidance can be facilitated through use of a graphical user interface running on a conventional personal computer (PC) or any other suitable computer wherein the GUI can be displayed using any suitable display screen, such a liquid crystal display (LCD), and the like.

A cluster of documents as referred to herein can be considered a collection of documents associated together based on a measure of similarity, and a cluster can also be considered a set of identifiers designating those documents.

A document as referred to herein includes text containing one or more strings of characters and/or other distinct features embodied in objects such as, but not limited to, images, graphics, hyperlinks, tables, charts, spreadsheets, or other types of visual, numeric or textual information. For example, strings of characters may form words, phrases, sentences, and paragraphs. The constructs contained in the documents are not limited to constructs or forms associated with any particular language. Exemplary features can include structural features, such as the number of fields or sections or paragraphs or tables in the document; physical features, such as the ratio of “white” to “dark” areas or the color patterns in an image of the document; annotation features, the presence or absence or the value of annotations recorded on the document in specific fields or as the result of human or machine processing; derived features, such as those resulting from transformation functions such as latent semantic analysis and combinations of other features; and many other features that may be apparent to ordinary practitioners in the art.

Also, a document for purposes of processing can be defined as a literal document (e.g., a full document) as made available to the system as a source document; sub-documents of arbitrary size; collections of sub-documents, whether derived from a single source document or many source documents, that are processed as a single entity (document); and collections or groups of documents, possibly mixed with sub-documents, that are processed as a single entity (document); and combinations of any of the above. A sub-document can be, for example, an individual paragraph, a predetermined number of lines of text, or other suitable portion of a full document. Discussions relating to sub-documents may be found, for example, in U.S. Pat. Nos. 5,907,840 and 5,999,925, the entire contents of each of which are incorporated herein by reference.

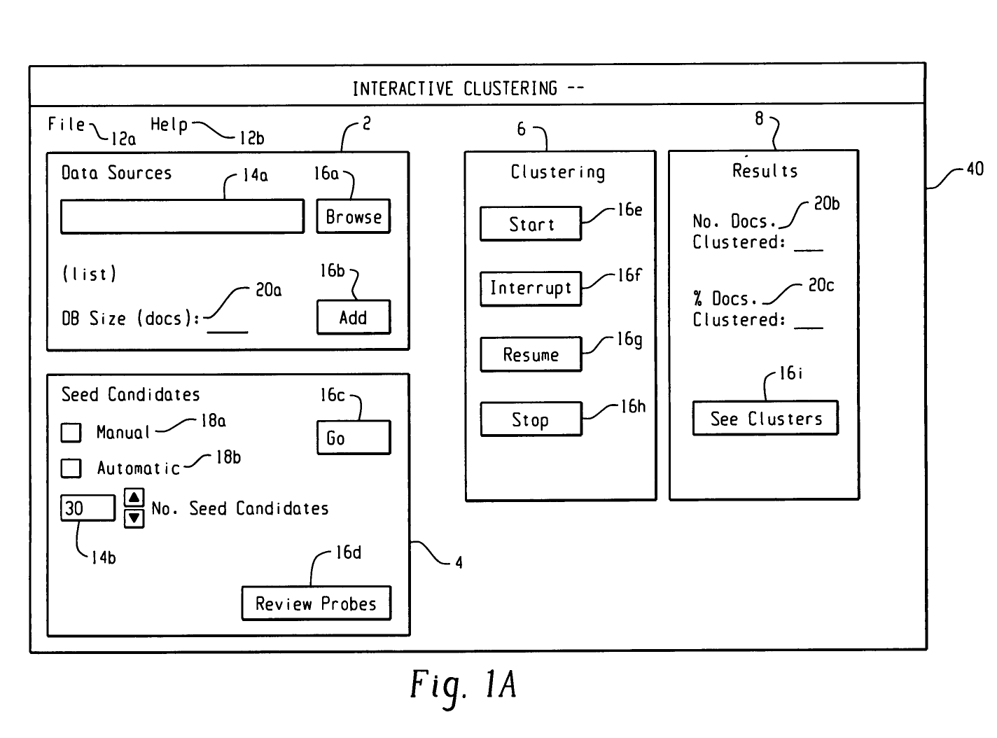

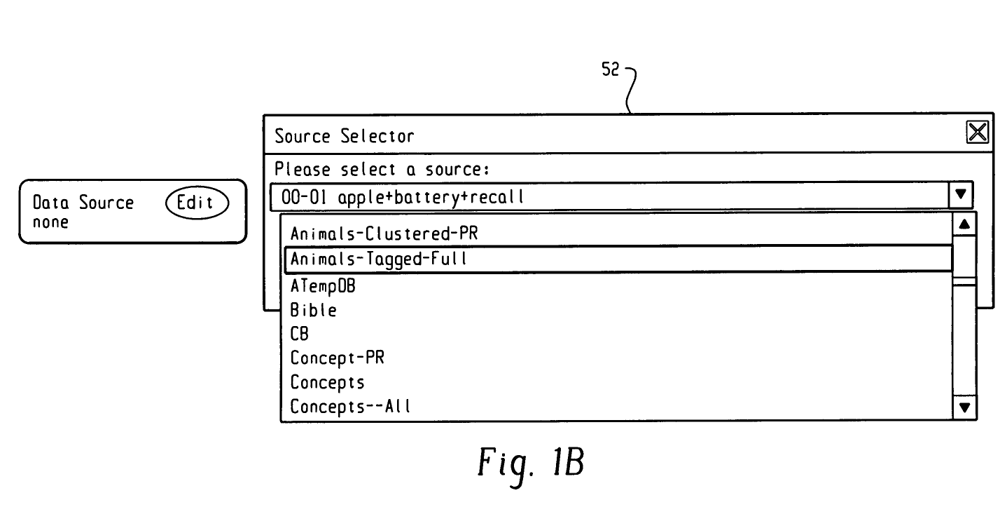

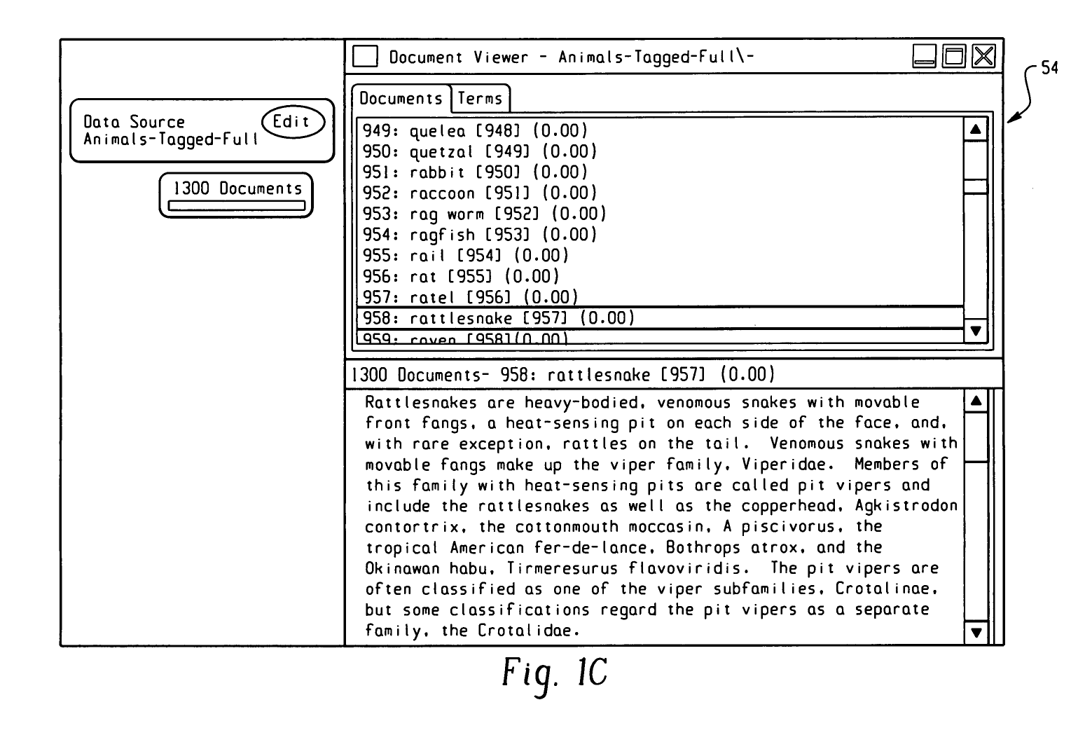

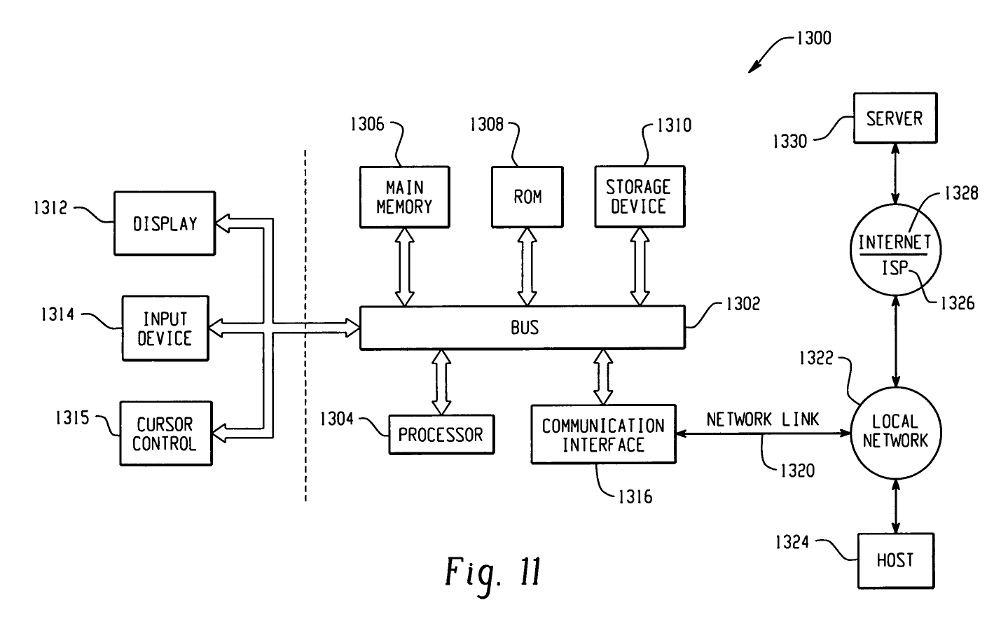

FIG. 1A illustrates an exemplary window 40 of a GUI that can be implemented on a conventional personal computer or any other suitable computer, such as the computer system illustrated in FIG. 11, discussed elsewhere herein, for permitting user interaction and user direction of a clustering process according to one aspect. The GUI comprises a set of interrelated computer-generated windows or pages for display on a display screen, such as an LCD, that include functionality that permits the user to interact with the setup and execution of a clustering algorithm. The window 40 of the GUI can be divided into graphical sections associated with certain functionality. In the example of FIG. 1A, for instance, section 2 can be associated with selecting one or more data sources containing documents that may be clustered, section 4 can be associated with selection of seed candidate documents from which to form clusters, section 6 can be associated with controlling the clustering process, and section 8 can be associated with monitoring and viewing clustering results. Such sections could also be arranged on separate pages labeled with selectable tabs, as will be appreciated by one of ordinary skill in the art.

The GUI can be navigated by a user using drop down menus 12a and 12b, data entry fields 14a and 14b, selection buttons 16a-16i, check boxes 18a and 18b, display fields 20a-20c, and the like. Among other things, the functionality of the GUI can permit the user to select one or more data sources of documents for clustering, to see, review and select/deselect “seed candidate” documents from which to generate clusters, to view rankings and scores associated with seed candidate documents, to start and stop execution of the clustering algorithm at will, and to permit various other types of functionality commonly known in connection with GUIs such as saving setup parameters, saving results to files, printing desired information, selecting viewing parameters, etc.

To select one or more data sources (collections of documents) for clustering, the user can enter the name and path of the data source, if known, into the data entry field 14a shown in FIG. 1A, and click the “Add” button 16b, for example. The selected data source(s) can then be listed below the data entry field 14a. The size of an individual data source selected (or the collective size of multiple data sources) can be displayed in field 20a. Also, the user can select a data source by clicking the “Browse” button 16a with a computer mouse, thereby causing a pop-up window 52 such as shown in the example of FIG. 1B to be displayed, which can permit the user to select a data source from among a list of possible data sources of documents for clustering. In addition, to gain further information a given data source (e.g., to assist the user in selecting an appropriate data source), the user can highlight one of the data sources (e.g., “Animals-Tagged-Full” in the example of FIG. 1B), and right click with a mouse to select a “Document Viewer” option from a list with another mouse click. Doing so can cause a pop-up window such as window 54 shown in the example of FIG. 1C to appear, which permits the user to see a list of documents and associated titles or topic headings in an upper portion of window 54, and which further permits the user to see text of individual documents in a lower portion of window 54 by selecting (e.g., with a mouse click) one of the documents from the list. The user can then navigate back to section 2 of the GUI window 40 shown in FIG. 1A, to add whatever data sources are desired by clicking the “Add” button 16b.

It will be appreciated that the encoding of a GUI according to the present disclosure, and the encoding of the exemplary clustering methods taught herein, can be carried out using any suitable software language such as C, C++, HTML, and/or Java, etc., and is within the purview of one of ordinary skill in the art in light of the functionality disclosed herein. Various aspects of the exemplary GUI shown in FIG. 1A will be discussed further throughout the disclosure in connection with other figures and functionality. It will also be appreciated that the GUI shown in FIG. 1A is simplified for purposes of illustration, exemplary in nature, and not intended to be limiting in any way. Those of ordinary skill in the art will appreciate that many variations in functionality, look, feel and navigation could be made to a GUI such as that shown in FIG. 1A for permitting a user to interact with a clustering process as disclosed herein.

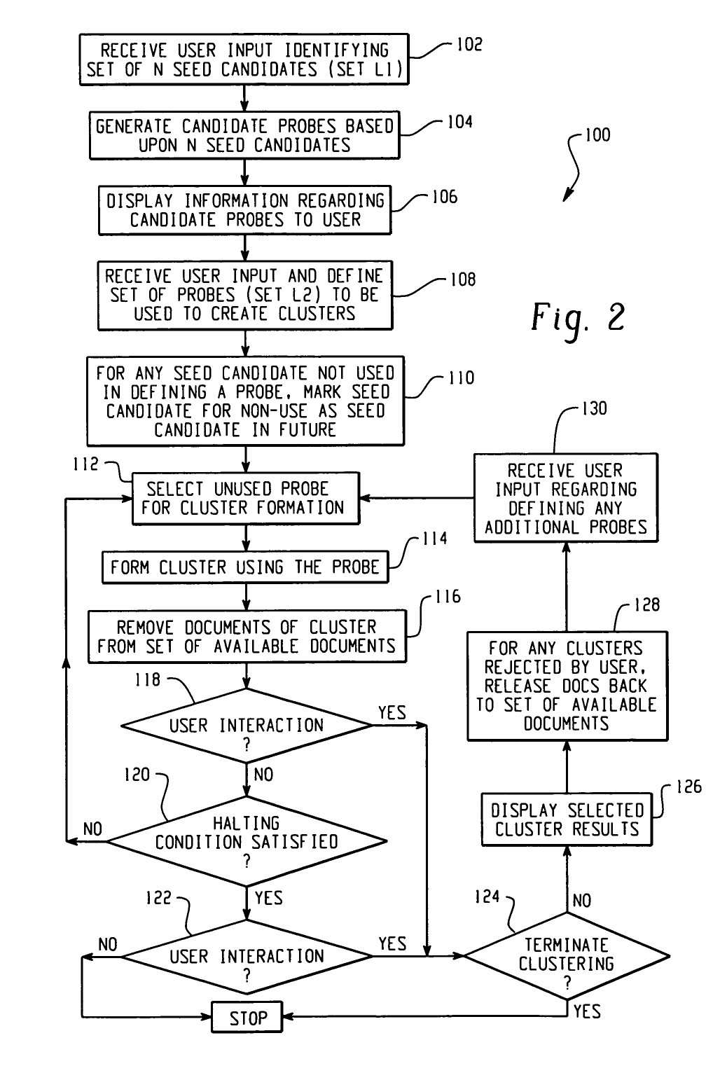

FIG. 2 illustrates an exemplary computerized method 100 for identifying clusters of documents that have some degree of similarity from among a set of documents that permits user interaction and direction of the clustering process. As noted above, a cluster can be considered a collection of documents associated together based on a measure of similarity, and a cluster can also be considered a set of identifiers designating those documents that have been associated together. The exemplary method 100, and other exemplary methods described herein, can be implemented using any suitable computer system comprising a processing system and a memory, such as the exemplary computer system illustrated in FIG. 11 and discussed elsewhere herein.

In the example of FIG. 2, at step 102, the computer system identifies a plurality of seed candidate documents (also referred to as a set L1 of N seed candidates for convenience). The phrase “seed candidate documents,” also referred to herein as “seed candidates” (SC) or “cluster seed candidates” (CSC), refers to documents whose terms and/or other features may be used to form “probes” from which clusters of documents are generated from among a set of documents. They are “candidates” because, as will be described further below, the user may decide not to use certain seed candidates in forming clusters of documents from among a set of documents. They are “seeds” because clusters of documents are generated using information from the seed candidate documents. The computer system can identify the plurality of seed candidates automatically (e.g., this can be a default approach requiring no user input), or the computer system can identify the plurality of seed candidate documents utilizing user input regarding the plurality of seed candidate documents (e.g., the user can select seed candidates manually or can make adjustments to seed candidates automatically selected), as discussed further below.

The number N of seed candidates from which to grow clusters can be a default value, e.g., 10, 20, 30, etc., that can be specified in a setup file, for example, and/or can also be set/changed by a user by entering a suitable number in a data entry field such as field 14b shown in FIG. 1A, or by clicking the up/down arrows to right of field 14b.

The set L1 of N seed candidates can be, for example, a ranked list of documents or an unranked set of documents, and can be generated in a variety of ways. For example, the user can specify a mode of manual selection or automatic selection of the seed candidates, e.g., by clicking the Manual check box 18a or the Automatic check box 18b shown in FIG. 1A, and by clicking the Go button 16c. If the user has selected manual selection, the user can be prompted with a pop window containing a “browse” button that permits the user to navigate in a conventional manner to desired drives and/or folders containing documents, for example. The source(s) of the documents for selection of the seed candidates can be the same as the source(s) of documents identified (e.g., at section 2 of FIG. 1A) to be clustered, or could be a different source(s). After navigating to the desired source for selecting the seed candidates, the user can view a list of document titles or filenames, for example, and the user can select desired seed candidates in any suitable way such as double-clicking on a desired document with a computer mouse, right-clicking on a document and selecting an appropriate field with another mouse click, selecting check boxes associated with the desired documents and clicking an “add” button, etc.

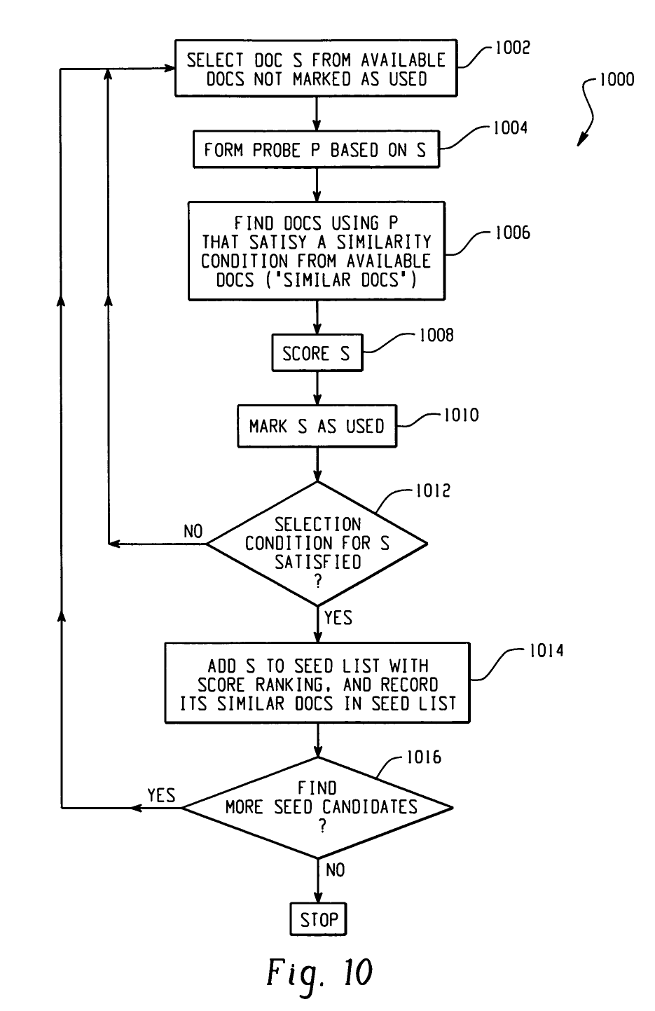

As noted above, the user can also specify automatic selection of the set L1 of N seed candidates, e.g., by selecting the Automatic selection box 18b in section 4 of FIG. 1A and by selecting the “Go” button 16c, for example. An automatically generated list of seed candidates can then be displayed in another pop-up window for the user's review (and for user editing if desired). As an example, a collection of seed candidates can be selected randomly from the set of documents to be clustered or from another source(s) of documents. Random selection can be beneficial because random selection of the seed candidates from set of documents to be clustered has the tendency to result in building and removing the most coherent and largest clusters from the set of documents first. Seed candidates could also be selected, for example, from a subset of documents in a ranked list, which can generated by any suitable approach, such as, for example, from a query executed on the set of documents, which generates scores for responsive documents. Seed candidates could be selected as a predetermined number or predetermined fraction of the highest ranking of those documents, or those ranking above a predetermined score, for example, or could be selected from another position in the ranked order (e.g., from a predetermined score range centered at or above the mean), for example. Another exemplary approach for generating an initial collection of seed candidates will be discussed later herein in connection with FIG. 10. If the user has selected automatic selection of seed candidates, the user may still review and edit the list of seed candidates (e.g., reject certain seed candidates), if desired.

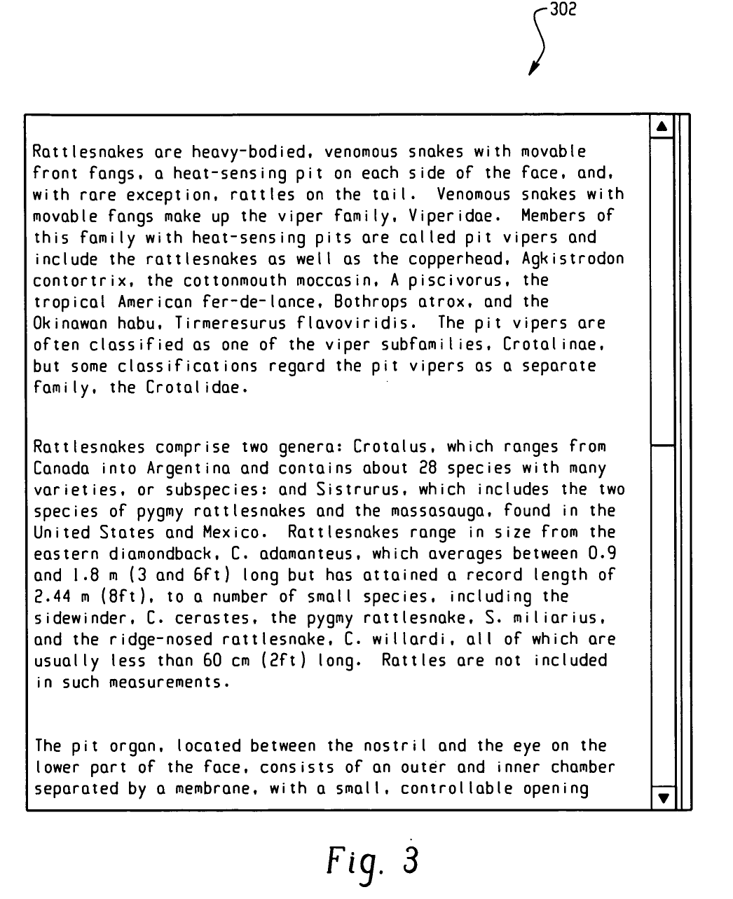

Regardless of whether the user chooses manual selection or automatic selection, the user has the ability to obtain additional information about any of the documents tentatively selected as seed candidates or under consideration as seed candidates. For example, according to one aspect, the user can review text of a given document shown in a list of documents by right clicking the document and selecting a “view” or “open” field to review text from the document. Such user action can cause a pop-up window containing document text to appear for the user's review, such as shown by pop-up window 302 in the example of FIG. 3. The scroll bar at the right-hand side of the pop-up window 302 shown in FIG. 3 permits the user review as much or as little text as desired. Such user review can be beneficial for informing the user's decision on whether or not to choose or accept a given document as a seed candidate

At step 104, the computer system generates candidate probes from which to generate clusters based upon the seed candidates. For example, a first candidate probe may be generated from a first seed candidate, a second candidate probe may be generated from a second seed candidate, and so forth. The candidate probes can each comprise one or more features and can be generated in any suitable manner. For example, for a particular seed candidate, a candidate probe can comprise the seed candidate itself, e.g., the terms from the text of the seed candidate, possibly combined with any other features of the seed candidate such as described elsewhere herein. Generating a candidate probe can be as simple as assigning or accepting the terms of a seed candidate to be the candidate probe (e.g., from a practical standpoint, the candidate probe can be the same as the seed candidate in a simple example). As another example, a candidate probe can comprise a subset of features selected from a seed candidate, such as a weighted (or non-weighted) combination of features (e.g., terms) of the particular seed candidate. As another example, a candidate probe can comprise a subset of features selected from multiple documents (including the particular seed candidate), such as a weighted (or non-weighted) combination of features (e.g., terms) of the multiple documents. The candidate probes are “candidates” because certain ones may or may not ultimately be used for forming clusters, depending upon user selection and/or refinement of the candidate probes, as will be discussed further herein. Candidate probes (and probes derived therefrom) can be generated by any suitable approach, such as, for example, those described in U.S. Patent Application Publication No. 20070112898 (“Methods and Systems for Probe-Based Clustering”), the entire contents of which are incorporated herein by reference.

As a general matter, forming a suitable probe (e.g., either a candidate probe or a probe from which clusters will actually be formed) based on one or more documents (e.g., a seed candidate document and possibly additional documents that are similar to the seed candidate document based on a measure of similarity as described elsewhere herein) can be accomplished in an automated fashion by the computer system by identifying features of the document(s), scoring the features, and selecting certain features (possibly all) based on the scores. Stated differently, probe formation can be viewed as a process that creates a probe P from a document set {D} (one or more documents) using a method M that specifies how to identify or features in documents and how to score or weight such terms or features, wherein the probe satisfies a test T that determines whether the probe should be formed at all and, if so, which features or terms the probe should include. Identifying distinct features of a document (or documents) and selecting all or a subset of such features for forming a probe is within the purview of ordinary practitioners in the art. For example, parsing document text to identify phrases of specified linguistic type (e.g., noun phrases), identifying structural features (such as the number of fields or sections or paragraphs or tables in the document), identifying physical features (such as the ratio of “white” to “dark” areas or the color patterns in an image of the document), identifying annotation features, including the presence or absence or the value of annotations, are all known in the art. Once such features are identified they can be scored using methods known in the art. One example is simply to count the number occurrences of a given identified feature, and to normalize each number of occurrences to the total number of occurrences of all identified features, and to set the normalized value to be the score of that feature. Depending upon the scores of the identified features, it may be decided not to form the probe at all based upon a given document or documents (e.g., because all of the scores or a combination of the scores fall below a threshold). Selection of a subset of features can be done, for example, by selecting those features that score above a given threshold (e.g., above the average score of the identified features) or by selecting a predetermined number (e.g., 10, 20, 50, 100, etc.) of highest scoring features. Other examples could be used as will be appreciated by ordinary practitioners in the art. Once the subset of features is selected, those features can be weighted, if desired, by renormalizing the number of occurrences a given feature to the total number of occurrences for the features of the subset, thereby providing a probe.

As suggested above, one exemplary subset of features (from one document or from multiple documents) to use as a probe can be a term profile of textual terms, such as described, for example, in U.S. Patent Application Publication No. 2004/0158569 to Evans et al., filed Nov. 14, 2003, the entire contents of which are incorporated herein by reference. One exemplary approach for generating a term profile is to parse the text and treat any phrase or word in a phrase of a specified linguistic type (e.g., noun phrase) as a feature. Such features or index terms can be assigned a weight by one of various alternative methods known to ordinary practitioners in the art. As an example, one method assigns to a term “t” a weight that reflects the observed frequency of t in a unit of text (“TF”) that was processed times the log of the inverse of the distribution count of t across all the available units that have been processed (“IDF”). Such a “TF-IDF” score can be computed using a document as a processing unit and the count of distribution based on the number of documents in a database in which term t occurs at least once. For any set of text (e.g., from one document or multiple documents) that might be used to provide features for a profile, the extracted features may derive their weights by using the observed statistics (e.g., frequency and distribution) in the given text itself. Alternatively, the weights on terms of the set of text may be based on statistics from a reference corpus of documents. In other words, instead of using the observed frequency and distribution counts from the given text, each feature in the set of text may have its frequency set to the frequency of the same feature in the reference corpus and its distribution count set to the distribution count of the same feature in the reference corpus. Alternatively, the statistics observed in the set of text may be used along with the statistics from the reference corpus in various combinations, such as using the observed frequency in the set of text, but taking the distribution count from the reference corpus. The final selection of features from example documents may be determined by a feature-scoring function that ranks the terms. Many possible scoring or term-selection functions might be used and are known to ordinary practitioners of the art. In one example, the following scoring function, derived from the familiar “Rocchio” scoring approach, can be used:

$$W ( t ) = IDF ( t ) \frac{{\sum }_{D}^{ } {TF}_{D} ( t )}{Np}$$

Here the score W(t) of a term “t” in a document set is a function of the inverse document frequency (IDF) of the term t in the set of documents (or sub-documents), or in a reference corpus, the frequency count TF_{D} of t in a given document D chosen for probe formation, and the total number of documents (or sub-documents) Np chosen to form the probe, where the sum is over all the documents (or sub-documents) chosen to form the probe. IDF is defined as

IDF(t)=log₂(N/nₜ)+1

where N is the count of documents in the set and nₜ is the count of the documents (or sub-documents) in which t occurs.

Once scores have been assigned to features in the document set, the features can be ranked and all or a subset of the features can be chosen to use in the feature profile for the set. For example, a predetermined number (e.g., 10, 20, 50, 100, etc.) of features for the feature profile can be chosen in descending order of score such that the top-ranked terms are used for the feature profile.

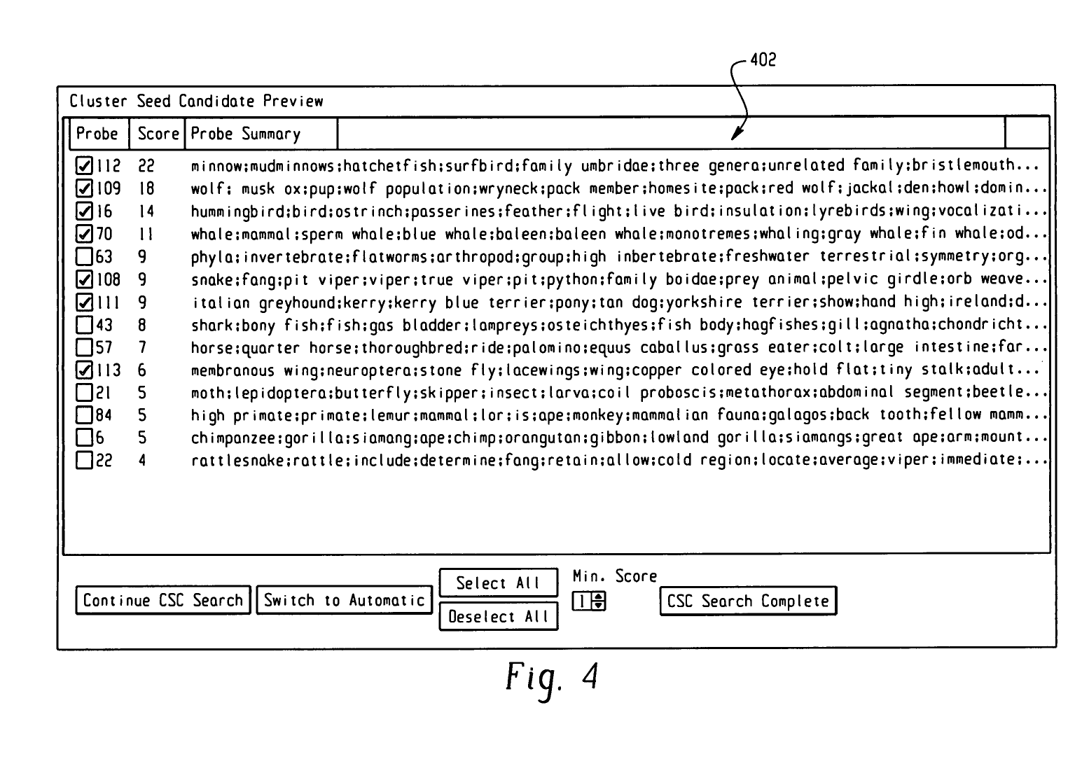

At step 106, information regarding the candidate probes is displayed to a user using a graphical user interface (GUI) and any suitable display screen, such an LCD or other display monitor. For example, after selection of the seed candidates, a pop up window can automatically appear for display on the GUI listing the set of candidate probes that have been automatically generated by the computer system from the seed candidates by a suitable method, such as the exemplary probe formation methods described above. Alternatively, the user could select a suitable button, such as the “review probes” button 16d shown in FIG. 1A to bring up a pop-up window containing information regarding the candidate probes. An exemplary pop-up window 402 illustrating information regarding candidate probes is shown in FIG. 4. As shown in the example of FIG. 4, the pop-up window 402 includes a “probe” column showing the identification number of a given candidate probe, a “score” column showing a probe score for a given candidate probe, a “probe summary” column listing terms (or more generally, features) associated with each candidate probe, and a set of check boxes, described further below, that permits a user to select a given candidate probe as a probe for actual cluster formation (or to leave the check box unselected, in which case the candidate probe is not used as a probe for cluster formation). In addition, the pop-up window 402 includes a button 404 for “Continue CSC Search,” where CSC refers to cluster seed candidate, i.e., a seed candidate, thereby permitting further identification of additional seed candidates, a button 406 for “Switch to Automatic” for switching to an automatic mode for selecting seed candidates as noted previously herein, buttons 408 and 410 to “Select All” and “Deselect All” seed candidates, respectively, up/down arrow buttons 412 for specifying a minimum probe score threshold that needs to be met in order for probes to be displayed, and a button 414 for “CSC Search Complete,” the selection of which can navigate the user back to a main GUI page, or to a clustering GUI page, for example, to begin cluster formation.

The probe score referred to above provides a measure of how well a given candidate probe represents documents in the set of documents being clustered, and thus provides useful information to a user as to whether or not to use the probe for cluster formation. Approaches for assigning such probe scores will be described elsewhere herein.

Referring again to FIG. 4, the number of candidate probes can be the same as the number of seed candidates from which the candidate probes were formed, or the number of candidate probes could be different in number (e.g., less). In the example of FIG. 4, the “probe” column, which shows the probe identification number, reveals that there were at least 113 probes in this example, and thus at least 113 seed candidates. However, as illustrated in this example, which lists fourteen probe summaries, it may be desirable to display information for only a subset of the top scoring probes (e.g., the M top scoring probes where M is a predetermined number, the top scoring percentage of probes, those probes scoring over a predetermined score value, etc.).

At step 108 of FIG. 2, the computer system receives user input regarding the candidate probes and defines a set of probes (also referred to set L2 of probes, for convenience) from which to generate clusters based upon the user input. For example, as noted above, the pop-up window shown in the example of FIG. 4 includes and a set of check boxes that permits a user to select a given candidate probe as a probe for actual cluster formation, or the user can deselect a candidate probe, in which case the candidate probe is not used as a probe for cluster formation. The default condition can be, for example, that all probes are initially automatically selected, leaving it to the user to deselect candidate probes that are not desired, or the default condition can be that all probes are initially deselected, leaving it to the user to select the candidate probes that are desired. By selecting or deselecting candidate probes, the user can provide user input from which the computer system defines probes that will actually be used in cluster formation (e.g., those which the user selected via the check boxes). In addition, if the user makes no changes to the candidate probes in an automatic selection context, for example, and retains all probes initially selected automatically by the computer system, that action by the user also qualifies as user input that the computer system uses to define the probes from which clusters will be formed. In addition, the user input provided at step 108 can include selection of button 404 to search for additional seed candidates, which may impact what probes are defined for cluster formation. In addition, defining a set of probes from the candidate probes can be as simple as assigning or accepting the candidate probes to be the set L2 of probes in light of the user's input to proceed in that manner (e.g., from a practical standpoint, the set of probes L2 can be the same as the set of candidate probes if the user refrains from making any changes to the candidate probes, in a simple example).

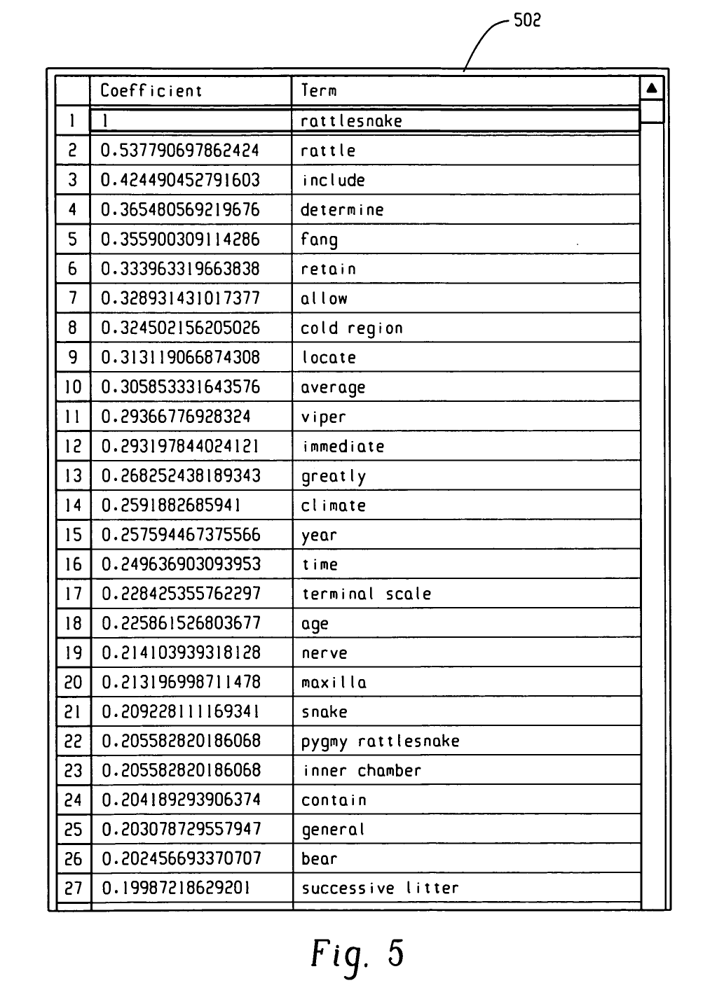

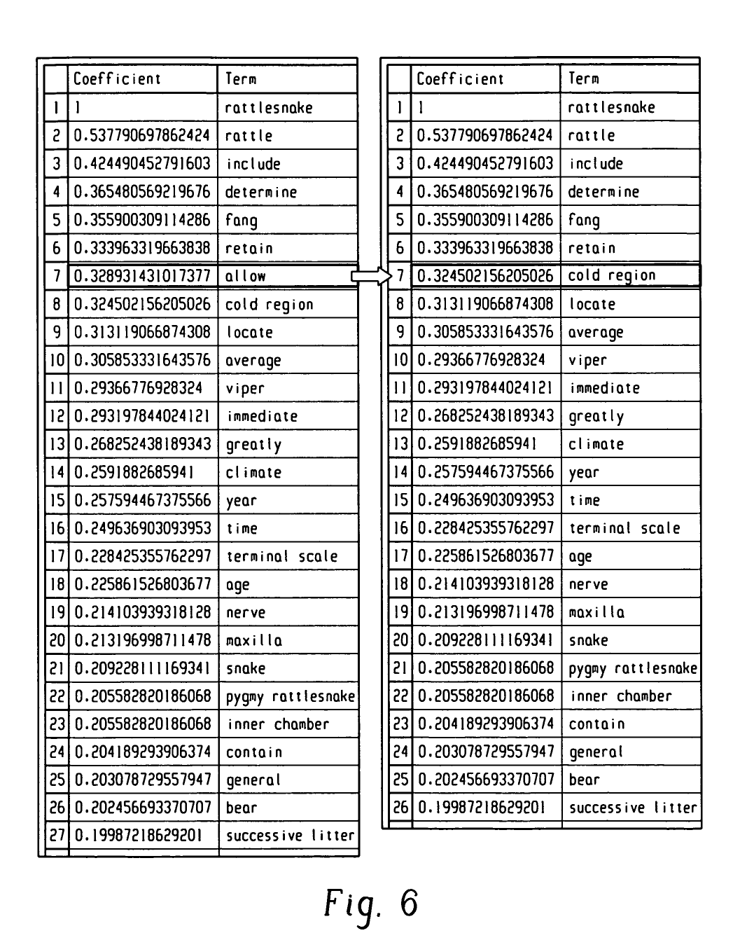

As another example of what may occur at step 108, if desired, the user can edit or refine a probe to be used in cluster formation by making changes to the terms (or more generally, features) of the probe. For example, by right clicking a given probe summary shown in FIG. 4, the user can cause another pop-up window to appear, such as window 502 shown in FIG. 5, which contains a larger list of the terms (or features) of that probe candidate, including, for example, a listing of the terms (or features) of the probe (see “Term” column) and weighting coefficients associated with the respective terms (see “Coefficient column). Such weighting coefficients may be determined by the computer system automatically based on analysis of the seed candidate document from which a given candidate probe was derived, wherein in the weighting-coefficient analysis can be carried out using any suitable techniques, such as the TF-IDF scoring approach or the Rocchio scoring approach, for example, described herein. As shown in the example of FIG. 6, the user can remove a term from a probe by right clicking the term to highlight it (left side of FIG. 6, the term “allow”), for example, and selecting a pop-up “delete” field with a mouse click, which causes that term to be deleted from the probe (right side of FIG. 6). The user could also add terms to a probe by right clicking a given probe summary such as shown in FIG. 4, right clicking that probe summary, and selecting an “add term” field with a mouse click, which then presents a pop-up window to the user prompting the user to type in the term to be added and, if desired, specifying a weighting coefficient.

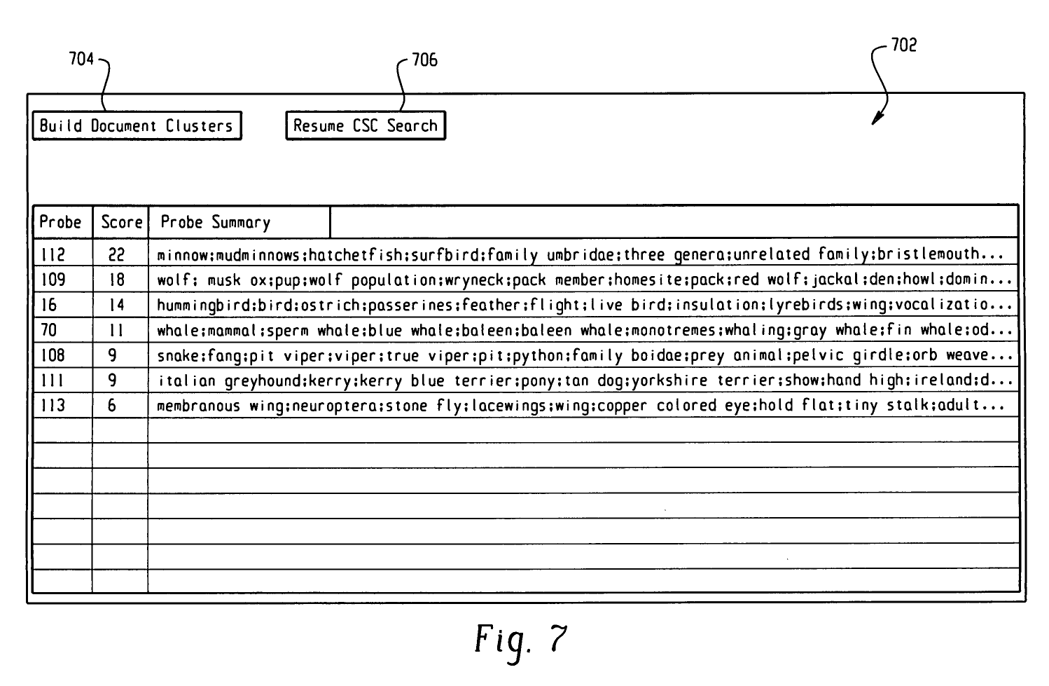

After completion of any editing or refinement of the candidate probes at step 108, thereby defining the probes to be used in forming clusters, the user may be presented with an updated version of the pop-up window 402 of FIG. 4, showing just those candidate probes that were retained, or the user may be presented with another pop-up window showing the results of the user input used to define the probes from which clusters will be formed. An example of such a pop-up window is window 702 illustrated in FIG. 7, which shows just those probe summaries for those probe candidates that were retained based on prior user input. In addition, window 702 may include additional buttons for navigating the GUI such as button 704 (“Build Document Clusters”), for initiating cluster formation using the probes defined based on the prior user input, and button 706 (“Resume CSC Search”) to return the user to appropriate GUI page(s) for identifying additional seed candidates or making changes to the set of seed candidates already generated.

Referring again to FIG. 2, if desired, the computer system can be configured to mark with a suitable flag or otherwise designate any seed candidate not used in defining a probe for non-use as a seed candidate in the future. In other words, in the context of a given clustering session, for example, such a seed candidate marked for non-use will not be displayed again to the user during any manual or automatic actions for selecting seed candidates.

At step 112, the computer system selects a probe, e.g., by random selection or by selecting the probe with the highest probe score, for example. Any approach can be used for selecting a probe for forming clusters. At step 114, the computer system forms a cluster of documents from among available documents of the set of documents using the probe by analyzing the available documents using the probe. Forming the cluster of documents comprises finding documents that satisfy a similarity condition relative to the probe and associating some or all of the documents that satisfy the similarity condition with a particular cluster of documents. As a general matter, any suitable clustering algorithm can be used at this stage that does not require analysis of all documents in the set of documents to form multiple clusters. Advantageous clustering approaches applicable to the methods set forth herein are disclosed in U.S. Patent Application Publication No. 20070112898 (“Methods and Systems for Probe-Based Clustering”), the entire contents of which are incorporated herein by reference.

As an example, at step 114, using a probe, documents are found that satisfy a similarity condition from among the available documents. This clustering process is carried out for one probe before moving on to another probe. In this way, once a cluster has been created for one probe, those documents are no longer among the available documents for clustering with the next probe (this makes cluster formation according to the present disclosure highly efficient). These documents that satisfy a similarity condition can be referred to as “similar documents” for convenience. In this regard, a measure of the closeness or similarity between the probe and another document(s) (similarity score) can be generated using any suitable process (referred to as a similarity process for convenience), and the measure of closeness can be evaluated to determine whether it satisfies a similarity condition, e.g., meets or exceeds a predetermined threshold value. The threshold could be set at zero, if desired, i.e., such that documents that provide any non-zero similarity score are considered similar, or the threshold can be set at a higher value. As with other thresholds described herein generally, determining an appropriate threshold for a similarity score is within the purview of ordinary practitioners in the art and can be done, for example, by running the similarity process on sample or reference document sets to evaluate which thresholds produce acceptable results, by evaluating results obtained during execution of the similarity process and making any needed adjustments (e.g., using feedback based on the number of similar documents identified is considered sufficient), or based on experience. As referred to herein, similarity can be viewed as a measure of the closeness or similarity between a reference document or probe and another document or probe. A similarity process can be viewed as a process that measures similarity of two vectors. In addition, the similarity scores of the responding documents can be normalized, e.g., to the similarity score of the highest scoring documents of the responding documents, and by other suitable methods that will be apparent to those of ordinary practitioners in the art.

It will be appreciated that the seed candidates can be among the available documents such that the seed candidates will be among the documents “searched” using the probe at step 114. Alternatively, the seed candidates need not be among the set of available documents. Both of these possibilities are intended to be embraced by the language herein “finding documents that satisfy a similarity condition using the probe from among the available documents” or similar language.

Various methods for evaluating similarity between two vectors (e.g., a probe and a document) are known to ordinary practitioners in the art. In one example, described in U.S. Patent Application Publication No. 2004/0158569, a vector-space-type scoring approach may be used. In a vector-space-type scoring approach, a score is generated by comparing the similarity between a profile (or query) Q and the document D and evaluating their shared and disjoint terms over an orthogonal space of all terms. Such a profile is analogous to a probe referred to above. For example, the similarities score can be computed by the following formula (though many alternative similarity functions might also be used, which are known in the art):

$$S ( {Q}_{i} , {D}_{j} ) = \frac{{Q}_{i} \cdot {D}_{j}}{\vert {Q}_{i} \vert \cdot \vert {D}_{j} \vert} = \frac{{\sum }_{k = 1}^{t} ( {q}_{ik} \cdot {d}_{jk} )}{\sqrt{{\sum }_{k = 1}^{t} {q}_{ik}^{2}} \cdot \sqrt{{\sum }_{k = 1}^{t} {d}_{jk}^{2}}}$$

where Qᵢ refers to terms in the profile and Dⱼ refers to terms in the document. Evaluating the expression above (or like expressions known in the art) provides a numerical measure of similarity (e.g., expressed as a decimal fraction). Then, as noted above, such a measure of similarity can be evaluated to determine whether it satisfies a similarity condition, e.g., meets or exceeds a predetermined threshold value. Thus, it will be appreciated that the similar documents found at step 114 can have scores that allow them to be ranked in terms of similarity to the probe P.

Additionally, at step 114, for the particular probe under consideration, some or all of the documents that satisfy the similarity condition (similar documents) are associated with a particular cluster of documents. The association can be done, for example, by recording the status of the documents that satisfy the similarity condition in the same database that stores the set of documents, or in a different database, using, for example, appropriate pointers, marks, flags or other suitable indicators. For example, a list of the titles and/or suitable identification codes for the set documents can be stored in any suitable manner (e.g., a list), and an appropriate field in the database can be marked for a given document identifying the cluster to which it belongs, e.g., identified by cluster number and/or a suitable descriptive title or label for the cluster. The documents of the cluster could also be recorded in their own list in the database, if desired. It will be appreciated that it is not necessary to record or store all of the contents of the documents themselves for purposes of association with the cluster; rather, the information used to associate certain documents with certain clusters can contain a suitable identifier that identifies a given document itself as well as the cluster to which it is associated, for example. It is possible that the particular cluster may contain only the similar documents, or it is possible that the particular cluster may also contain additional documents beyond the similar documents (e.g., if it was known that at least some other documents should be associated with the cluster prior to initiating the method 100). This aspect is applicable for clusters identified by whatever approach may be used.

As noted above, just some as opposed to all of the similar documents identified at step 114 can be associated with a cluster. Associating some, as opposed to all of the similar documents together, can be accomplished using a variety of approaches. For example, a predetermined percentage of the top scoring similar documents may be identified (e.g., top 80%, top 70%, top 60%, top 50%, top 40%, top 30%, top 20%, etc.), wherein it will be appreciated that the similarity scores of the similar documents can be determined as described elsewhere herein. Alternatively, it may be desirable to configure the clustering algorithm to associate with the cluster only the top scoring predetermined number of documents or those documents that exceed another threshold value. It will be appreciated that other approaches for identifying a subset of the similar document for association with a cluster can also be used.

It will also be appreciated that in the process of actual cluster formation, one or more new probes may be created, possibly iteratively, from one or more documents (e.g., top scoring documents) of the evolving cluster that have not previously been used in probe formation, to further identify documents to associate with the evolving cluster, as described in U.S. Patent Application Publication No. 20070112898 (“Methods and Systems for Probe-Based Clustering”). As will be apparent from the discussion herein, these new probes generated during creation of an evolving cluster can also be viewed and adjusted by a user by interrupting the clustering process in any suitable way such as described herein.

At step 116, documents associated with the cluster that has been formed are removed from consideration from the set of available documents, e.g., by any suitable flagging or other type of designation that will cause the computer system to skip over those documents when forming additional clusters, or by physically removing those documents from the database, for instance.

At step 118, the computer system may receive a user command or instruction indicating that some user interaction with the process 100 is desired. This user command or instruction could occur at any point between steps 112 and 120 and, in fact, could occur while other steps are in the process of being carried, e.g., while the computer system is forming a cluster of documents at step 114, for example. It will also be appreciated that the user interaction at step 118 can take a variety of forms and may or may not interrupt other aspects of the process 100, such as temporarily or permanently halting the formation of clusters, depending upon the nature of the user interaction. In any event, if a command for user interaction is received at step 118, the system will determine at step 124 whether the command involves terminating the entire clustering process. For example, the user may wish to entirely quit the process 100 by selecting the Stop button 16h shown in FIG. 1A. If this is the case, the process 100 stops. Otherwise the computer system will respond appropriately to the type of user command at steps 126, 128 and 130, the execution of which may or may not occur depending upon the nature of the user command(s) and the order of which would also depend upon the nature of the user command(s).

For example, if the user desires to see cluster results for clusters that have already formed, the user can click button 16i shown in FIG. 1A, and the computer system will display at step 126 cluster results selected by the user. The user can review such results without interrupting or temporarily suspending the process of forming clusters, which can continue to occur. On the other hand, if the user wants to temporarily halt the formation of clusters, e.g., to review clustering results without continuing to form clusters at the same time, the user can click the Interrupt button 16f shown in FIG. 1A to interrupt clustering, and could then click button 16i to see clusters. To resume clustering, the user could click the Resume button 16g, or a similar “resume” button that may be displayed in a results window.

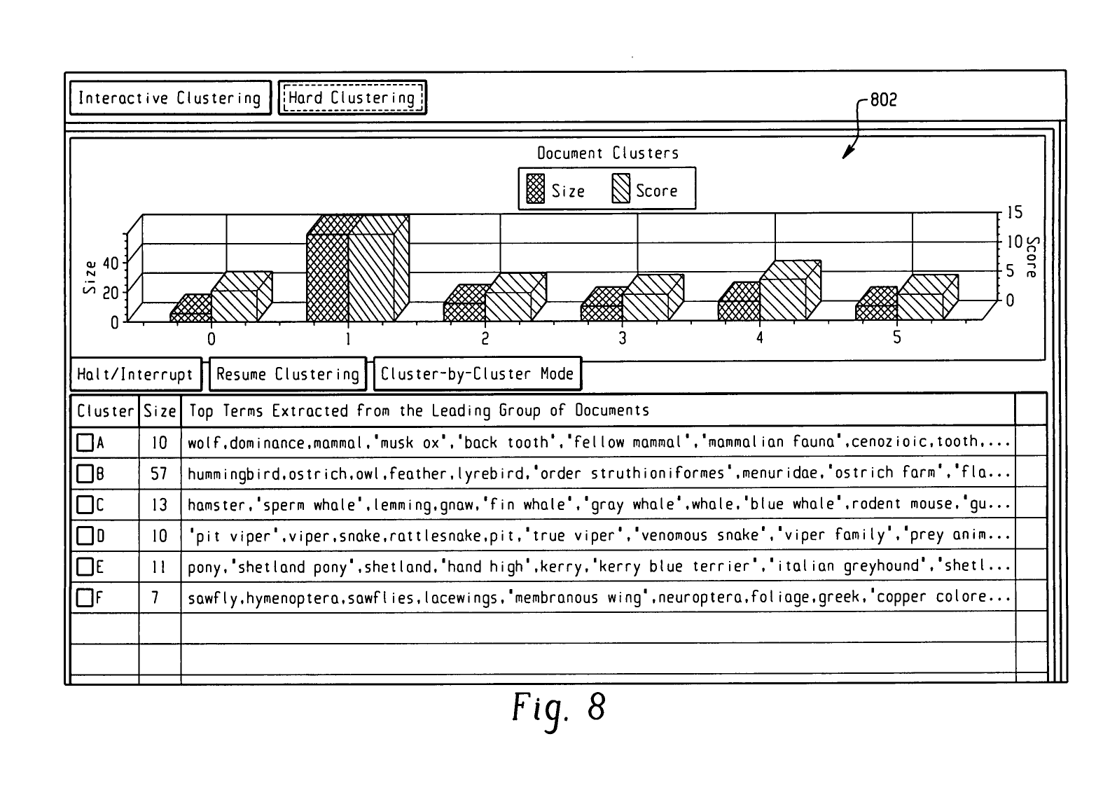

Clustering results can be displayed for user review in a variety of ways. For example, FIG. 8 illustrates an exemplary pop-up window 802 that can be displayed in response to a user command to see cluster results. The window 802 may include, for example, an upper portion graphically illustrating the sizes and scores of clusters formed thus far in a bar graph format, and may include a lower portion that includes a table-format listing of the clusters formed thus far, e.g., designated by letter (A, B, C, etc.) or any other suitable designation, associated sizes of the clusters, and top terms (e.g., most common or highest scoring terms) occurring in the corresponding cluster of documents as an indicator of the subject matter of the cluster. Note that, while there were seven probes reflected in FIG. 7, only six of these survived to produce clusters as reflected in FIG. 8. By selecting a tab associated with this screen, the users can continue automatically to form additional clusters (by selecting the “Hard Clustering” tab) or return to an earlier phase of the process 100 to search for more seed candidates (by selecting the “Interactive Clustering” tab). In addition, window 802 may include buttons for halting or interrupting the cluster formation process (by selecting “Halt/Interrupt”), for resuming the clustering process if it has been halted (by selecting “Resume Clustering”), and for selecting a cluster-by-cluster mode (by selecting “Cluster-by-Cluster Mode”) in which the computer system automatically interrupts the clustering process after forming a given cluster to permit the user to review details associated with that cluster prior to resuming clustering to form the next cluster.

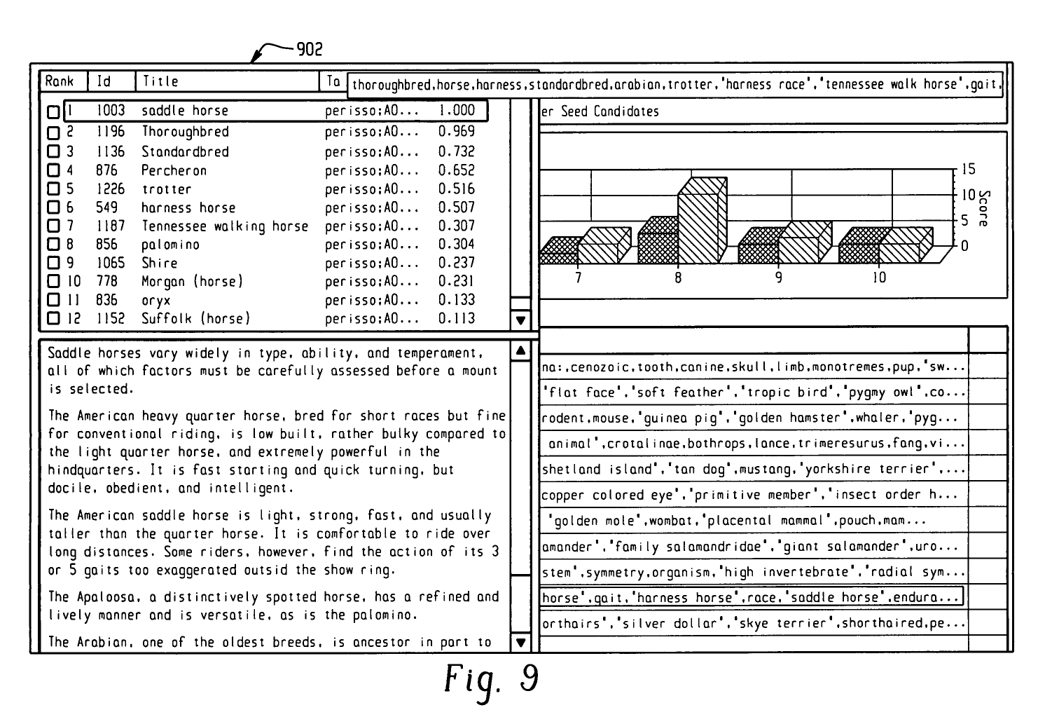

Of course, other types of clustering results could be displayed and other ways of viewing clustering results could be used as will be appreciated by those of skill in the art. For example, by right clicking on one of the “top term” summaries shown in window 802, the user can be presented with a list of options including a “view documents” field that a user may select with a mouse click. Doing so can cause another pop-up window to be displayed with a scrollable list of document titles or file names, any of which can be further selected by the user (e.g., by right clicking or other suitable selection) so that the user can review actual text of one or more documents of any cluster. As another example, the list of options presented to the user by right clicking on one of the “top term” summaries of a given cluster may include a “view cluster details” option (or other suitable designation) that presents the user with a pop-up window such as window 902 shown in the example of FIG. 9. With window 902, the user can view the member documents of the cluster, their scores in the cluster, and the content of selected documents (such as shown for the “Saddle Horse” document in the example of FIG. 9). Check boxes shown in the upper right hand portion of FIG. 9 enable the user to mark individual documents for exclusion from the cluster.

In addition, at this stage, the user may decide to reject certain clusters at step 128 after having reviewed their various details including statistics and/or subject matter (context). For example, by right clicking on one of the “top term” summaries shown in window 802, the user can be presented with a list of options including a “reject cluster” field that a user may select with a mouse click. Doing so causes that cluster to be rejected and its documents returned to the set of available documents that can be analyzed in further cluster formation. Of course, other types of functional controls such as check boxes and associated action buttons could also be used to carry out rejection of a cluster as will be evident from the discussion presented herein.

Additionally, at step 130, the user may choose to select an additional probe(s) in light of the user's review of clustering results, in which case the computer system may receive a user input regarding defining any such additional probe(s). In such a case, the user can navigate to the appropriate screen(s) of the GUI for selecting additional seed candidates, and proceed to make whatever selections are desired, such as previously described herein. At that point, the computer system can form candidate probes, which the user may review and modify, if desired, such that the computer system can define any additional probe(s) for cluster formation, such as previously described herein. The process 100 can then proceed back to step 112 where another unused probe is chosen for further clustering of documents from among the available documents.

If no such user command or instruction is received at step 118, the process continues to step 120 where it is determined whether a halting condition has been satisfied. The halting condition can be satisfied, for example, when clusters have been generated for all of the probes or when all of the documents have been analyzed and cluster assignments have been made, whether or not all of the probes have been used. In addition, for example, the halting condition could be satisfied when the entire set of documents has been analyzed for clustering, after a predetermined number of clusters has been created, after a predetermined percentage of the documents in the set of documents has been clustered, after a predetermined number of clusters of a minimum predetermined size has been created, or after a predetermined time interval has occurred. Any combination of these halting conditions can be utilized such that satisfaction of any one satisfies the halting condition. Other conditions can also be used as will be appreciated by ordinary practitioners in the art.

If a halting condition is not satisfied at step 120 (i.e., clustering should continue), steps 112-116 are repeated to form at least one other cluster. In this regard, another probe is selected, and another similarity condition is utilized to find similar documents for a new cluster. The other similarity condition of the next iteration can be the same as the previous similarity condition, or it can be different from the previous similarity condition. It can be desirable to change (e.g., raise or lower) the similarity condition as iterations proceed to compensate for the removal of documents associated with previous iterations of clustering. Also, at each iteration of cluster formation, the status of which documents are “available” can be updated at step 116 so that documents associated with a cluster are no longer considered available documents for clustering. Another command for user interaction can also occur again at step 118.

If the halting condition is satisfied at step 120 (i.e., clustering should not continue, at least temporarily), the process proceeds to step 122, where again a user command for user interaction may be received by the computer system. If no user command is received at step 122, the process 100 stops. If, however, a user command for user interaction is received at step 122, the process proceeds again to step 124 and possibly steps 126-130 as already described. User interaction can be desirable after the halting condition has been satisfied at step 120 since, as noted above, the halting condition may arise because a predetermined percentage of documents of the set of documents has been clustered or because a predetermined number of clusters has been generated, for example. In other words, satisfaction of the halting condition at step 120 does not mean that the clustering process is necessarily entirely completed. It may be that only a portion of the documents have been clustered and a limited number of dominant clusters has been generated, and after the user's review of this information, the user may choose to continue clustering. This can be accomplished for example, by the user clicking a “resume clustering” button such as described previously herein. When this occurs after the halting the condition has been satisfied, the computer system can automatically update the halting condition or set of halting conditions so that the clustering process does not terminate or become suspended as a result of having already satisfied one halting condition. For example, at this stage the set of halting conditions can be automatically updated to cluster a next predetermined percentage of documents or form another predetermined number of clusters or continue clustering until exhaustion of the set of documents, as may be desired. Such preferences or other preferences can be set in any suitable setup window or file.

If desired, documents of a given cluster can be ranked (e.g., listed in ranked order in a list) as the given cluster is identified. Finding documents using methods that generate scores or weights, such as discussed above, can automatically provide ranking information. Also, the method 100 can comprise providing an identifier (referred to as a “content identifier” for convenience) that describes the content of a given cluster. For example, the title of the highest ranking document of a given cluster could be used as the content identifier. As another example, all or some terms (or description of features) of the probe could be used as the content identifier, or all or some terms of a new probe generated from multiple close documents that satisfy another similarity condition could be used as the content identifier.

As noted above, candidate probes and probes used to form clusters of documents can be scored, and those “probe scores” can be displayed to a user. To the extent that the terms and/or other features of a seed candidate document can be used to form a probe, the “probe score” of a given probe can also be a “seed score” for the seed candidate document from which the probe was derived. An example of determining a probe score for a probe (or a seed score for a seed candidate document from which the probe is derived) will now be described. For all or some of the documents in the set of documents, a query can be executed using a probe formed from a given document over the set of documents, yielding a list of responsive documents for that probe ranked according to their similarity scores. For each set of responsive documents associated with a given probe, a collective score of the responsive documents can be generated, e.g., by summing the scores of each responsive document, or by calculating the average response score, etc. This collective score can then be associated with the probe to provide a “probe score” for the probe that produced a given set of responsive documents. Similarly, this probe score can also be considered a “seed score” for the document from which the probe was derived since that document might be considered as a seed candidate.

Such seed scores can also be used to rank seed candidate documents for purposes of identifying the most potentially beneficial seed candidates, and this process can be used in identifying the set of seed candidates referred to above in step 102 of FIG. 2. For example, the seed scores referred to above can be ranked and normalized against the highest seed score. Then, those documents with associated seed scores above a predetermined threshold can be selected as a set of seed candidate documents to be presented to a user for formation of candidate probes and possibly to be used as probes for forming clusters of documents, as described previously. Alternatively, a predetermined number of the documents with the highest seed scores can be selected as seed candidate documents for presentation to a user. It will be appreciated that this approach can be used by the computer system as another example of “automatic” selection of seed candidates referred to above in connection with selection of seed candidates at step 102 of FIG. 2.

In addition, with regard to scoring probes, additional probes that may be created during the formation of a particular, evolving cluster, such as mentioned above, can also be scored in the manner described to assess the quality of the probe or the quality of the documents responding to the probe, for example, for purposes of determining whether formation of the particular cluster should continue or be terminated.

Another approach for automatically generating an initial set of seed candidate documents from the set of documents will now be described with reference to FIG. 10. Once this initial set of seed candidates is automatically generated as described below in connection with FIG. 10, the exemplary process 100 can be carried out using those initial seed candidates beginning with step 102. Thus, this set of initial seed candidates generated according to the example of FIG. 10 can serve as the starting point from which the user can provide user input to for identifying a set of N seed candidates at step 102 for further processing as set forth in FIG. 2.

Referring to FIG. 10, to begin automatically generating a set of initial seed candidates, a particular document (referred to as “doc S” for convenience) is selected from among available documents of a set of documents at step 1002. The doc S is a document that has not been marked “used” as having already been considered a seed candidate. In the first iteration of the process 1000, none of the documents will have been marked “used” as having already been considered as potential seed candidates. In subsequent iterations of the process 1000 any docs marked “used” are ignored as potential seed candidates, since they have already been considered. The set of documents can be stored in any suitable memory or database in one or multiple locations. Documents of the set of documents previously associated with a cluster of documents are not included among the available documents. Document S can be selected in any suitable way. For example, document S can be selected randomly from the available documents. Random selection can be beneficial because random selection of the particular document S has the tendency to result in building and removing the most coherent and largest clusters from the set of documents first. S could also be selected, for example, from a subset of documents in a ranked list, which can generated by any suitable approach, such as, for example, from a query executed on either the set of documents or the available documents, which generates scores for responsive documents. Document S can be selected, for example, as the highest ranking of those documents, or from another position in the ranked order (e.g., from a predetermined score range centered at or above the mean), or via any other suitable approach such as described in U.S. Patent Application Publication No. 20070112898 (“Methods and Systems for Probe-Based Clustering”).

At step 1004, a probe P is generated based on the particular document S. This probe is not the same as the candidate probes or the probes from which clusters are generated described previously herein. Rather, this probe P and other probes generated in subsequent iterations of process 1000 are simply generated and used as an initial phase in generating a collection of initial seed candidates, which may be reviewed by a user to identify a set of N seed candidates at step 102 of FIG. 2. The probe P can comprise one or more features and can be generated in any suitable manner, such as previously described herein. For example, the probe can comprise the document S itself, e.g., the terms from the text of the document S, possibly combined with any other features of the document S such as described previously herein. As another example, the probe can comprise a subset of features selected from the particular document S, such as a weighted (or non-weighted) combination of features (e.g., terms) of the particular document S. As another example, the probe can comprise a subset of features selected from multiple documents (including the particular document S), such as a weighted (or non-weighted) combination of features (e.g., terms) of the multiple documents (e.g., the probe can be generated from a seed candidate document and possibly additional documents that are similar to the seed candidate document based on a measure of similarity as described elsewhere herein).

At step 1006, documents are found that satisfy a similarity condition using the probe P from among the available documents. These documents can be referred to as “similar documents” for convenience. In this regard, a measure of the closeness or similarity between the probe and another document(s) (similarity score) can be generated using a suitable process (referred to as a similarity process for convenience), and the measure of closeness can be evaluated to determine whether it satisfies a similarity condition, e.g., meets or exceeds a predetermined threshold value, such as previously described herein. For example, the threshold could be set at zero, if desired, i.e., such that documents that provide any non-zero similarity score are considered similar, or the threshold can be set at a higher value. As with other thresholds described herein generally, determining an appropriate threshold for a similarity score is within the purview of ordinary practitioners in the art and can be done, for example, by running the similarity process on sample or reference document sets to evaluate which thresholds produce acceptable results, by evaluating results obtained during execution of the similarity and making any needed adjustments (e.g., using feedback based on the number of similar documents identified is considered sufficient), or based on experience. As referred to herein, similarity can be viewed as a measure of the closeness or similarity between a reference document or probe and another document or probe. A similarity process can be viewed as a process that measures similarity of two vectors. In addition, the similarity scores of the responding documents can be normalized, e.g., to the similarity score of the highest scoring documents of the responding documents, and by other suitable methods that will be apparent to those of ordinary practitioners in the art. Various methods for evaluating similarity between two vectors (e.g., a probe and a document) are known to ordinary practitioners in the art, exemplary approaches for which have previously been described herein.

At step 1008, the document S is scored. The scoring of S can be labeled a “seed score” for convenience and is a measure of an object density in the neighborhood of the probe P, which is based, at least in part, on the document S. The seed score can be determined in variety of ways. As one example, the seed score can be the normalized sum of the similarity scores of all of the similar documents. As another example, the seed score can be the normalized sum of the similarity scores of a certain top-ranking number or percentage of the similar documents. As a further example, the seed score can be the number of documents that are “close” to the probe based on another more stringent similarity condition (“closeness condition”). For example, if the similar documents were considered to be those documents with similarity scores relative to the probe P above a predetermined threshold t1, the close documents could be those with similarity scores above a predetermined threshold t2, where t2>t1. As another example, if the similar documents were considered to be those documents with similarity scores above the mean similarity score of the similar documents, the close documents could be those with similarity scores above a threshold that is a predetermined amount or predetermined percentage above the mean similarity score of the similar documents. As mentioned previously herein, determining appropriate thresholds is within the purview of an ordinary practitioner in the art. Of course any other suitable closeness condition can be used to place a greater similarity requirement on the close documents relative to the probe as compared to the similar documents, as will be appreciated by ordinary practitioners in the art. In any event, as one example, the number of close documents—those that meet or exceed a closeness condition (or that number divided by the number of similar documents)—can be used as the seed score. Other types of seed scores can also be used as will be appreciated by ordinary practitioners in the art. Since the similar documents found at step 1006 of FIG. 10 can already have rank scores, the close documents can simply be designated as such in view of those scores. In other words, a separate query or other type of search is not necessary to identify the close documents.

At step 1010, the document S is marked as “used” or is flagged in any other suitable manner to indicate that the document S is being evaluated as a potential seed candidate so that it need not be evaluated later as a potential seed candidate, regardless of whether it is accepted or rejected as a seed candidate (step 1010 could occur at a different location in the ordering of steps). At step 1012, the document S is tested to see whether a selection condition (referred to as a “seed selection condition” for convenience) is satisfied. A document is considered a good seed candidate if it is situated in a dense enough area of the set of documents under consideration and, hence, can be successfully used to initiate cluster formation. As examples, the seed selection condition can be that the potential seed has at least a predetermined number of close documents (described above), or that the seed score for the potential seed is above a given threshold, or that the seed score is above the average seed score of all seeds in a list of other seed candidates (referred to as a “seed list” for convenience, which will be described later). Other suitable seed selection conditions could also be used as will be appreciated by ordinary practitioners in the art. If the seed selection condition is not satisfied, the process proceeds again to step 1002, where another document S is selected, and the remaining steps are repeated.

If document S satisfies the selection condition at step 1012, it is added to a list of seed candidates (referred to herein as a “seed list” for convenience) as indicated at step 1014. Also, at step 1014, the seed score determined at step 1008 is also recorded in the seed list, and the similar documents found at step 1006 for document S are recorded in the seed list as well. (The similar documents themselves do not need to be “saved” to the list; rather, any suitable records/identifiers identifying the similar documents can be saved to the list.) Thus, the seed list may contain a listing of seed candidates, their associated seed scores, and identifiers of their associated similar documents, appropriately marked or flagged to maintain the association between a given seed candidate, its seed score, and its particular similar documents. It should be noted that there can be overlap between the recorded similar documents of different seed candidates, i.e., similar documents recorded for one seed candidate may also be recorded as similar documents for another seed candidate. In addition, where additional seed candidates are generated after clustering has begun, e.g., because an initial set of seed candidates has been consumed by association with one or more clusters, appropriating updating of the seed list requires those clustered documents to be “removed” for all the seed candidates they are associated with, and those documents are also “removed” from consideration as seed candidates. Removing from consideration can include physical removal from the database or databases where the documents are stored or removal from the index or other data structures that record information including statistics about the documents and the database or databases.

At step 1016, it is determined whether or not to find more seed candidates. In this regard, any suitable condition can be used to determine whether more seeds should be found. For example, the condition can be whether or not a predetermined number of seed candidates has been found, or whether the number of seed candidates as function of the number of documents of the set of documents (e.g., a predetermined percentage of the number of documents of the database) has been found. As another example, the condition can be whether the number of seed candidates as a function of the number of documents of the set of documents has been found AND whether a predefined condition on the completeness of the search for seed candidates has been satisfied. Other approaches can also be used as will be appreciated by ordinary practitioners in the art. If the answer at step 1016 is yes, the process proceeds back to step 1002 to find more seed candidates; if not, the process 1000 stops, and the process 100 can begin at step 102, such as has been previously described herein.

Exemplary methods described herein can have notable advantages compared to known clustering approaches. For example, the user can actively control and guide the clustering process from the point of forming the probes through the point of reviewing cluster results and potentially rejecting clusters that are not desired so as to enhance the relevance of the clusters formed. This also permits the user to preview the most popular coherent topics in the database, guide the clustering process, and then create document clusters only for selected topics. Also, the user can control the clustering process so as to discover only certain clusters of documents, such that there is no need to cluster the entire document collection. Also, if random selection is used to choose a document from which to generate a probe for clustering, the most coherent and largest clusters tend to be generated first because the randomly selected document is likely a member of one of the larger thematic groups of the set of documents. If a seed list of seed candidates is established, selecting the highest (or a highly ranking) seed candidate from which to generate a probe also tends to generate the largest and most coherent clusters first. For each cluster, the methods described herein can rank documents according to their importance to the cluster. Meaningful labels or identifiers of cluster content for a given cluster can be generated from terms or descriptions of features from the probe that created the cluster. The exemplary methods do not require processing the entire set of documents to achieve final clusters; rather, final, complete clusters are generated during each iteration of cluster formation. Thus, the user can be presented with final results early in the process for what are likely the most important clusters. The methods are computationally efficient and fast because each cluster is removed in a single pass, leaving fewer documents to process during the next iteration of cluster formation.

Meaningful clustering results can be displayed to a user using any suitable display, such as an LCD or other monitor, clustering results can be stored in any suitable computer readable medium for later access and further analysis, and/or clustering results can be communicated to other hardware, software, and users.

### Hardware Overview

FIG. 11 illustrates a block diagram of an exemplary computer system upon which an embodiment of the invention may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312 for displaying information to a computer user. An input device 1314, including alphanumeric and other keys, is coupled to bus 1302 for communicating information and command selections to processor 1304. Another type of user input device is cursor control 1315, such as a mouse, a trackball, or cursor direction keys for communicating direction information and command selections to processor 1304 and for controlling cursor movement on display 1312.

The exemplary methods described herein can be implemented with computer system 1300, or any other suitable computer system, for carrying out document clustering. The clustering process can be carried out by processor 1304 by executing sequences of instructions and by suitably communicating with one or more memory or storage devices such as memory 1306 and/or storage device 1310 where the set of documents and clustering information relating thereto can be stored and retrieved, e.g., in any suitable database. The processing instructions may be read into main memory 1306 from another computer-readable medium, such as storage device 1310. However, the computer-readable medium is not limited to devices such as storage device 1310. For example, the computer-readable medium may include a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read, including any modulated waves/signals (such as radio frequency, audio frequency, or optical frequency modulated waves/signals) containing an appropriate set of computer instructions that would cause the processor 1304 to carry out the techniques described herein. Execution of the sequences of instructions causes processor 1304 to perform process steps previously described herein. In alternative embodiments, hard-wired circuitry may be used in place of or in combination with software instructions to implement the exemplary methods described herein. Thus, embodiments of the invention are not limited to any specific combination of hardware circuitry and software. For instances, whereas one processor 1304 is illustrated in FIG. 11, it should be appreciated that the exemplary methods disclosed herein can be carried out using any suitable processing system, such as one or more conventional processors located in one computer system or in multiple computer systems acting together.

Computer system 1300 can also include a communication interface 1316 coupled to bus 1302. Communication interface 1316 provides a two-way data communication coupling to a network link 1320 that is connected to a local network 1322 and the Internet 1328. It will be appreciated that the set of documents to be clustered can be communicated between the Internet 1328 and the computer system 1300 via the network link 1320, wherein the documents to be clustered can be obtained from one source or multiples sources. Communication interface 1316 may be an integrated services digital network (ISDN) card or a modem to provide a data communication connection to a corresponding type of telephone line. As another example, communication interface 1316 may be a local area network (LAN) card to provide a data communication connection to a compatible LAN. Wireless links may also be implemented. In any such implementation, communication interface 1316 sends and receives electrical, electromagnetic or optical signals which carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the “Internet” 1328. Local network 1322 and Internet 1328 both use electrical, electromagnetic or optical signals which carry digital data streams. The signals through the various networks and the signals on network link 1320 and through communication interface 1316, which carry the digital data to and from computer system 1300, are exemplary forms of modulated waves transporting the information.

Computer system 1300 can send messages and receive data, including program code, through the network(s), network link 1320 and communication interface 1316. In the Internet 1328 for example, a server 1330 might transmit a requested code for an application program through Internet 1328, ISP 1326, local network 1322 and communication interface 1316. In accordance with the invention, one such downloadable application can provides for carrying out document clustering as described herein. Program code received over a network may be executed by processor 1304 as it is received, and/or stored in storage device 1310, or other non-volatile storage for later execution. In this manner, computer system 1300 may obtain application code in the form of a modulated wave, which can then be permanently or temporarily stored on a computer-readable medium (e.g., in RAM).

Components of the invention may be stored in memory or on disks in a plurality of locations in whole or in part and may be accessed synchronously or asynchronously by an application and, if in constituent form, reconstituted in memory to provide the information required for retrieval and/or execution of the methods disclosed herein.

While this invention has been particularly described and illustrated with reference to particular embodiments thereof, it will be understood by those skilled in the art that changes in the above description or illustrations may be made with respect to form or detail without departing from the spirit or scope of the invention. For example, while flow diagrams of the figures herein show process steps occurring in exemplary orders, it will be appreciated that all steps do not necessarily need to occur in the orders illustrated.

What is claimed is:

1. A computerized method for forming clusters of documents from among a set of documents, the method comprising:
(a) identifying a plurality of seed candidate documents;
(b) generating candidate probes based upon the seed candidate documents, the candidate probes each comprising one or more features from the seed candidate documents;
(c) displaying information regarding the candidate probes to a user;
(d) receiving user input regarding the candidate probes and defining a set of probes from which to form clusters of documents based upon the user input regarding the candidate probes;
(e) selecting a probe and forming a cluster of documents from among available documents of the set of documents using the probe, wherein forming the cluster of documents comprises finding documents that satisfy a similarity condition relative to the probe and associating some or all of the documents that satisfy the similarity condition with a particular cluster of documents; and
(f) repeating step (e) using another probe as the probe and using another similarity condition as the similarity condition until a halting condition is satisfied to form at least one other cluster of documents,
wherein those documents of the set of documents previously associated with a cluster of documents are not included among the available documents.

2. The method of claim 1, comprising:
receiving a user command for user interaction regarding forming clusters of documents;
displaying clustering results to the user.

3. The method of claim 2, comprising:
receiving a user command to reject a cluster of documents that was formed; and
releasing the documents of the rejected cluster back to the set of available documents.

4. The method of claim 2, comprising:
receiving a user command to define an additional probe for further cluster formation after receiving the command for user interaction; and
forming a cluster of documents from among the available documents using the additional probe.

5. The method of claim 2, wherein the user command for user interaction is received prior to satisfying the halting condition.

6. The method of claim 2, wherein the user command for user interaction is received after satisfying the halting condition.

7. The method of claim 1, wherein identifying a plurality of seed candidate documents is carried out utilizing user input regarding the plurality of seed candidate documents.

8. An apparatus for identifying clusters of documents from among a set of documents, comprising:
a memory; and
a processing system coupled to the memory, wherein the processing system is configured to:
(a) identify a plurality of seed candidate documents;
(b) generate candidate probes based upon the seed candidate documents, the candidate probes each comprising one or more features from the seed candidate documents;
(c) display information regarding the candidate probes to a user;
(d) receive user input regarding the candidate probes and defining a set of probes from which to form clusters of documents based upon the user input regarding the candidate probes;
(e) select a probe and forming a cluster of documents from among available documents of the set of documents using the probe, wherein forming the cluster of documents comprises finding documents that satisfy a similarity condition relative to the probe and associating some or all of the documents that satisfy the similarity condition with a particular cluster of documents; and
(f) repeat step (e) using another probe as the probe and using another similarity condition as the similarity condition until a halting condition is satisfied to form at least one other cluster of documents,
wherein those documents of the set of documents previously associated with a cluster of documents are not included among the available documents.

9. The apparatus of claim 8, wherein the processing system is configured to:
receive a user command for user interaction regarding forming clusters of documents; and
display clustering results to the user.

10. The apparatus of claim 9, wherein the processing system is configured to:
receive a user command to reject a cluster of documents that was formed; and
release the documents of the rejected cluster back to the set of available documents.

11. The apparatus of claim 9, wherein the processing system is configured to:
receive a user command to define an additional probe for further cluster formation after receiving the command for user interaction; and
form a cluster of documents from among the available documents using the additional probe.

12. The apparatus of claim 9, wherein the user command for user interaction is received prior to satisfying the halting condition.

13. The apparatus of claim 9, wherein the user command for user interaction is received after satisfying the halting condition.

14. The apparatus of claim 8, wherein the processing system is configured to identify a plurality of seed candidate documents utilizing user input regarding the plurality of seed candidate documents.

15. A computer readable medium comprising processing instructions for identifying clusters of documents from among a set of documents, wherein the processing instructions cause a processing system to:
(a) identify a plurality of seed candidate documents;
(b) generate candidate probes based upon the seed candidate documents, the candidate probes each comprising one or more features from the seed candidate documents;
(c) display information regarding the candidate probes to a user;
(d) receive user input regarding the candidate probes and defining a set of probes from which to form clusters of documents based upon the user input regarding the candidate probes;
(e) select a probe and forming a cluster of documents from among available documents of the set of documents using the probe, wherein forming the cluster of documents comprises finding documents that satisfy a similarity condition relative to the probe and associating some or all of the documents that satisfy the similarity condition with a particular cluster of documents; and
(f) repeat step (e) using another probe as the probe and using another similarity condition as the similarity condition until a halting condition is satisfied to form at least one other cluster of documents,
wherein those documents of the set of documents previously associated with a cluster of documents are not included among the available documents.

16. The computer readable medium of claim 15, wherein the computer readable medium comprises processing instructions that cause a processing system to:
receive a user command for user interaction regarding forming clusters of documents; and
display clustering results to the user.

17. The computer readable medium of claim 16, wherein the computer readable medium comprises processing instructions that cause a processing system to:
receive a user command to reject a cluster of documents that was formed; and
release the documents of the rejected cluster back to the set of available documents.

18. The computer readable medium of claim 16, wherein the computer readable medium comprises processing instructions that cause a processing system to:
receive a user command to define an additional probe for further cluster formation after receiving the command for user interaction; and
form a cluster of documents from among the available documents using the additional probe.

19. The computer readable medium of claim 16, wherein the user command for user interaction is received prior to satisfying the halting condition.

20. The computer readable medium of claim 16, wherein the user command for user interaction is received after satisfying the halting condition.

21. The computer readable medium of claim 15, wherein the computer readable medium comprises processing instructions that cause a processing system to identify a plurality of seed candidate documents utilizing user input regarding the plurality of seed candidate documents.
